(19) United States
(12) Patent Application Publication
(10) Pub. No.: US 2011/0178813 A1
(43) Pub. Date: Jul. 21, 2011

(54) Automated continuing medical education system

(76) Inventor: Michael Allan Moore, Danville, VA (US)

(21) Appl. No.: 12/804,466

(22) Filed: Jul. 22, 2010

Related U.S. Application Data
(60) Provisional application No. 61/227,548, filed on Jul. 22, 2009.

(51) Int. Cl. G06Q 50/00

(52) U.S. Cl. 705/2

(57) ABSTRACT

An integrated continuing medical education and treatment system is implemented as a system, a process, and an article of manufacture. A treatment goal memory stores clinical treatment goal data associated with at least one or more disease. An educational memory stores instructional education data associated with at least one disease and a treatment delta; the treatment delta is the difference between a clinical treatment goal data and corresponding data relevant to a disease of inquiry. A processor is adapted to receive a healthcare provider's selection of a disease of inquiry and electronic medical record data relevant to any disease of inquiry. The clinical treatment goal data may be queried for a disease matching a disease of inquiry. The goal data is compared with the electronic medical record data to determine a treatment delta. The continuing medical education data is selected based on the disease of inquiry and the treatment delta.

### CROSS REFERENCE TO RELATED APPLICATIONS

This application claims the benefit of U.S. Provisional Application No. 61/227,548 filed Jul. 22, 2009, which is hereby incorporated by reference in its entirety.

### STATEMENT REGARDING FEDERALLY SPONSORED RESEARCH OR DEVELOPMENT

Not Applicable

### BACKGROUND OF THE INVENTION

1. Field of the Invention

The invention relates to physician and healthcare professional continuing medical education. More particularly, the invention is directed to a point of care automated continuing medical education (POCAME) system that is patient-centric and provider-specific.

2. Description

Physicians and other Healthcare Professionals (HCP) such as nurses, nurse practitioners, physician assistants, nurse mid-wives, clinical pharmacists, physical therapists, respiratory therapists, and others, require Continuing Medical Education (CME) after completion of their formal professional education. CME is critical to ongoing quality patient care and patient safety by maintaining the HCP's knowledge and clinical competency in the medical area for which he/she was trained. In addition, CME is required to maintain HCP professional licensure. CME is accredited by the applicable HCP's professional society. Physician CME is accredited by the Accreditation Council for Continuing Medical Education; nurse/nurse practitioner CME, by the American Nurses Credentialing Center's Commission on Accreditation; and pharmacist CME, by the American Council for Pharmacy Education. Healthcare professional CME is currently provided through live educational events such as lectures or workshops, internet-based learning activities, and various enduring materials such as published medical summaries, written educational materials, audio/video recordings including such recordings in digital formats. To participate in any of these current CME formats, the HCP almost always must leave direct patient care.

The current accreditation criteria for physician CME require that a continuous process of professional improvement be used in developing and evaluating the CME process. Continuous quality improvement (i.e., Plan, Do, Check, Act) that is used in industry and hospital quality programs should be applied to a HCP's CME. Physicians should continually assess their knowledge and clinical competency to identify any professional gaps, i.e., the difference between evidence-based optimal care and the observed care a patient is receiving. Educational programs should be designed to address the identified professional gaps. After the educational intervention, there should be a reassessment of the physician's knowledge and/or clinical competencies with additional educational improvement activities being developed as needed. The ultimate measure of a physician's competency is in terms of patient outcomes and patient safety. This same process can and should be applied to all HCP CME. After completion of a CME activity, the HCP is required to maintain a record with certificates of CME participation.

An improved Continuing Medical Education process is needed. Over the past several years, four developments have created a need for an improved CME process: (1) provider accountability for quality of patient care; (2) the reduction of time available to a HCP for CME; (3) concern about the effectiveness of CME to change the learner's clinical care and improve clinical outcomes; and (4) concern about commercial bias within CME programs.

First, healthcare payers and consumers increasingly demand evidence from HCPs of the quality and safety of their care. The medical reimbursement model, “Pay for Performance,” is a direct result of the increasing focus and demand for quality patient outcomes and healthcare provider accountability. In a “Pay for Performance” healthcare system, a physician or other HCP is paid proportionally based on his/her patient's clinical outcomes of care. Better healthcare outcomes (i.e., optimal treatment outcomes) would provide more reimbursement or payment to the HCP. Such a system is in place for Medicare payment to hospitals with the HHS Hospital Compare web-based tool. It is anticipated that a similar payment process for outpatient care will be required of physicians based on their outpatient outcomes (such as blood pressure control of hypertensive patients).

Second, physicians and other HCPs have less and less time to obtain CME. Today, there is a greater understanding of disease pathophysiology, and there is a greater array of treatments both of which have the potential of curing infections, improving chronic diseases, slowing cancerous growths, and overall, extending the life span and quality of life for the majority of patients. New medical knowledge is being developed and, simultaneously, disseminated at expeditious rates to HCPs and to patients. The internet and the 24/7 information services provide new medical information often as news items, rather than validated medical advances. In addition, direct-to-consumer advertising sometimes raises patients' expectations, often without a fair balance of equal or less expensive alternative treatments. In addition, a number of other influences create time challenges for the practice of medicine. There is an increasing amount of oversight by various agencies and authorities, such as healthcare payers, which requires additional documentation and restricts treatment on all aspects of clinical care. This increasing documentation requires more time for the many calls and faxes from and to third party payers to justify needed care. In general, the majority of physicians are being paid less while their practice overhead relentlessly increases each year.

To overcome the less-in and more-out financial conundrum, physicians often try to increase practice volume. Some physicians start work earlier in the morning, and work later in the evening. At the same time, physicians seek to keep abreast of the new medical knowledge and to provide the best possible patient care. Yet clinic days are too long, and the non-clinic days so few, such that the time for CME is seriously diminished, not to mention diminished personal time. Unfortunately, less clinical time for each patient can adversely affect patient care quality.

Currently, CME is typically obtained by leaving the patient and undertaking one of the following: (i) going to a formal educational activity, such as a lecture or conference; (ii) logging onto an internet or computer based educational activity; (iii) reviewing hard copy CME educational material; (iv) or turning to a handheld device to seek generic medical information. Over the past ten years, there has been little growth in the number of live CME programs while there has been great growth in the number of internet based CME activities as physicians find less time to attend live activities. Both CME formats require loss of productive clinical time to reach and participate in the education, and there is no assurance that the education obtained is what the physician needs to help a particular patient. In a recent medical review article, it was demonstrated that there is little predictable change in physician clinical behavior following the majority of CME activities (Davis D, et al., “Impact of Formal Continuing Medical Education: Do Conferences, Workshops, Rounds, and Other Traditional Continuing Education Activities Change Physician Behavior or Health Care Outcomes?” JAMA, September 1999; 282: 867-874). There is, at best, a 50% chance that a physician will change his/her clinical behavior as a result of a CME lecture. (Id). The odds for change can be improved using case studies (i.e. patient-centric learning), but it is not uniformly predictable.

Third, unfortunately, some CME may not provide valid information, may not be appropriate to the HCP's knowledge base (scope of practice), may not be easily available, and may not be in an educational format that facilitates learning.

Fourth, and finally, there is increasing concern about the commercial bias that can (and at times does) occur in CME. In 2007, the Macy Foundation published a landmark review and analysis of physician CME (Slawson, David C., Josiah Macy, Jr. Foundation, Continuing Education in the Health Professions: Improving Healthcare through Lifelong Learning 94 (2007), /http://www.josiahmacyfoundation.org/documents/pub_ContEd_in HealthProf.pdf./ This report reviewed the scientific knowledge concerning adult (physician and other HCP) learning. It concluded that the current CME process is not optimal, and there is concern about the amount of commercial bias in currently available CME.

Healthcare professional CME should be based on adult learning principles and should be tailored to the clinical world in which medical care is delivered. There are 9 attributes of adult learning that could contribute to an improved HCP CME process. First, CME should be available at the Point of Care (POC) similar to the increasing availability of Point of Care Treatment (POCT). The CME must be precisely what the physician or HCP needs to know in order to provide care to a patient while the HCP is in an exam room with the patient (Slawson, David C., Josiah Macy, Jr. Foundation, Continuing Education in the Health Professions: Improving Healthcare through Lifelong Learning 94 (2007), /http://www.josiahmacyfoundation.org/documents/pub_ContEd_in HealthProf.pda CME is always about a patient and should be an integral part of practice. To quote Dr. Robert Harden from the Macy Report, CME must be “just-for-you” learning and “just-in-time” learning Harden, R. M., A New Vision for Distance Learning and Continuing Medical Education, J. Continuing Educ. Health Prof. 23:43 (2005). CME must be available when the physician needs it for a patient's care, not just when the doctor has time to obtain it. The education must provide practical, patient-centric content that assists the HCP immediately in knowing what to do and how to do it. (Moore, D. E., Josiah Macy, Jr. Foundation, Continuing Education in the Health Professions: Improving Healthcare through Lifelong Learning 51-52 (2007), /http://www.josiahmacyfoundation.org/documents/pub_ContEd_in HealthProf.pdf/.

Second, Point of Care CME needs to be applicable for or directed to a specific patient. As an example, to know what additional treatment is needed to reduce a hypertensive patient's blood pressure to goal, the HCP does not need CME including a review of cardiovascular disease epidemiology before receiving the needed patient specific treatment information. The HCP at the POC immediately needs to know—for this patient, taking these medications, with these associated medical problems and/or end organ diseases, and at this clinic visit (time)—what additional treatment (based on validated, commercial free, evidence-based medicine) could or should be prescribed.

Third, CME should be not only patient-centric, but also learner (HCP)-centric. Current CME is presented in a one-size-fits-all manner. There is little effort made to determine what knowledge or competencies the physician learner brings to the educational activity Fletcher, S. W., Josiah Macy, Jr. Foundation, Continuing Education in the Health Professions: Improving Healthcare through Lifelong Learning 38 (2007), /http://wwwjosiahmacyfoundation.org/documents/pub_{—}ContEd_in HealthProf.pdf/. Effective CME should be based on the physician's knowledge on the subject and provide new information from that point. CME should be provided in a manner that is specific for the physician's scope of practice.

Fourth, CME should be in a learning format that can be quickly assimilated. It should answer a specific clinical question in as brief amount of time as possible. It should be given in small bites of relevant information rather than in a long comprehensive review (Moore, D. E., Josiah Macy, Jr. Foundation, Continuing Education in the Health Professions: Improving Healthcare through Lifelong Learning 45 (2007), /http://www.josiahmacyfoundation.org/documents/pub_ContEd_in HealthProf.pdf/.

Fifth, only valid, evidenced-based, and practical medical information should be provided.

Sixth, Point of Care CME should be available in an automated (passive to the HCP learner) manner or in an interrogative (active) manner in which the HCP asks the question.

Seventh, the CME should be free from any commercial bias.

Eighth, the CME should be accredited for Category 1 CME credit.

Ninth, CME credit should be made available automatically for the HCP learner participating in a CME activity.

### SUMMARY OF THE INVENTION

An aspect of the system of the present invention is an integrated CME and medical care (treatment) recommendation system. This system includes a processor coupled with a treatment goal memory for storing clinical treatment goal data associated with at least one or more disease(s); the processor is also coupled with an educational memory for storing CME data associated with at least one or more disease and a treatment delta. The treatment delta is a difference between clinical treatment goal data and corresponding treatment data relevant to a disease of inquiry of a particular patient. The processor is adapted to receive an HCP user's selection of a disease of inquiry and electronic medical record (EMR) data relevant to any disease of inquiry. The processor has service software executable on the processor and configured (i) to query one or more clinical treatment goal datum for a disease matching the disease of inquiry, (ii) to compare the matching treatment goal data with the EMR data to determine a treatment delta, (iii) to select CME data based on the disease of inquiry and the treatment delta, and (iv) to provide the CME data to the HCP user.

Optionally, at least a portion of the EMR data may be received from one or more points of care sensors in communication with the processor. The service software executable on the processor may be further configured to provide an evaluation inquiry to the HCP of the CME data. Optionally, the service software may be configured to provide a certificate of completion for the CME bearing a completion date, CME credit hours earned, and a name of the accredited CME provider. In another embodiment, the processor may be in communication with a network having at least one recipient computer, and the service software executable on the processor is further configured to transmit over the network the CME certificate of completion to the at least one recipient computer for the HCP. The processor may be coupled with a CME credit memory and configured to maintain a record of CME credit completed, and the service software executable on the processor is further configured to provide a report of the CME credit earned by the HCP. In some applications, the clinical treatment goal level data and the EMR data may be level 4 interoperable. In other applications, the clinical treatment goal level data and the electronic medical record data may be interoperable at levels 3 and 4, with level 3 data being machine-organizable data, including HL-7 messages, for example, and level 4 being machine-interpretable data.

The present invention extends to a process for the integration of HCPs' CME and the HCPs' patients' treatment. This process involves the steps of (i) storing in a treatment goal memory clinical treatment goal data associated with at least one or more disease; (ii) storing in an educational memory CME data associated with at least one or more diseases and a treatment delta, wherein the treatment delta is a difference between clinical treatment goal data and corresponding data relevant to a disease of inquiry; (iii) receiving an HCP user's selection of a disease of inquiry and EMR data relevant to such disease of inquiry; (iv) querying the treatment goal data for a disease matching the disease of inquiry, comparing the matching treatment goal data with the electronic medical record data to determine a treatment delta; (v) selecting CME data based on the disease of inquiry and the treatment delta; and (vi) providing CME data to the HCP user.

Optionally, in this process, at least a portion of the EMR data is received from one or more points of care sensor in communication with the processor. An alternative embodiment of this process includes the step of providing (sending) an evaluation inquiry to the HCP of the CME data and upon completion of the CME evaluation. Some embodiments may include the step of providing a certificate of completion for the CME bearing a completion date, CME credit hours earned, and a name of the accredited CME provider. In some cases, the certificate of completion may be provided electronically. Some embodiments may include the step of maintaining a record of the CME credit completed by the HCP. In some embodiments, the clinical treatment goal level data and the EMR data comprise level 4 data or both level 3 and level 4 data.

The present invention extends to an article of manufacture, which comprises a computer readable medium. Stored on the medium may be a computer program for providing continuing medical education in a variety of educational mediums including but not limited to written material, audio, video, digital, and simulated educational formats. The program involves: (i) a first code segment which, when executed on a computer stores in a treatment goal memory clinical treatment goal level data associated with at least one or more diseases; (ii) a second code segment which, when executed on a computer stores in an education memory CME data associated with at least one or more diseases and a treatment delta, wherein the treatment delta is a difference between clinical treatment goal data and corresponding data relevant to a disease of inquiry; (iii) a third code segment which, when executed on a computer accepts an HCP user's selection of a disease of inquiry and EMR data relevant to such a disease of inquiry; (iv) a fourth code segment which, when executed on a computer queries the treatment goal data for a disease matching the disease of inquiry and compares the matching treatment goal data with the EMR data to determine a treatment delta; (v) a fifth code segment which, when executed on a computer selects CME data based on the disease of inquiry and the treatment delta; (vi) a sixth code segment which, when executed on a computer provides the CME data to the HCP user; and (vii) a seventh code segment which, when executed on a computer provides an evaluation of the CME data that was provided to the HCP.

Optionally, at least a portion of the EMR data may be received from one or more points of care sensor in communication with the processor. The program may have a number of optional code segments, such as an eighth code segment which, when executed on a computer, provides an evaluation inquiry to the HCP of the CME data. An optional ninth code segment which, when executed on a computer, may provide a certificate of completion for the CME bearing a completion date, CME credit hours earned, and a name of the accredited CME provider. In some cases, the ninth code segment may provide the certificate of completion to the at least one recipient electronically. An optional tenth code segment which, when executed on a computer, may maintain a record of CME credit completed and provides a report of the CME credit earned by the HCP. In some cases, the clinical treatment goal level data and the EMR data comprise level 4 or both level 3 and level 4 data.

### BRIEF DESCRIPTION OF THE DRAWINGS

FIG. 1 shows a flow diagram of the initial HCP interface.

FIG. 2 shows a flow diagram of an automated CME query.

FIG. 3 shows a flow diagram of a theoretical CME query.

FIG. 4 shows a flow diagram of a manual CME query.

is an illustration of CME effectiveness analysis

FIG. 5 shows a flow diagram of potential HCP responses.

FIG. 6 shows an alternate flow diagram of the initial HCP interface.

FIG. 7 shows an alternate flow diagram of an automated CME query.

FIG. 8 shows an alternate flow diagram of a theoretical CME query.

FIG. 9 shows an alternate flow diagram of a manual CME query.

FIG. 10 is an illustration of the information flow of the POCAME system.

FIG. 11 shows the information flow in the POCAME system.

FIG. 12 shows additional information may be requested from the HCP.

FIG. 13 illustrates the process for integrated education of HCP's.

### DETAILED DESCRIPTION OF THE INVENTION

The following definitions and acronyms are provided for convenience, and should be construed as in addition to, or not intended to limit, the customary meanings that may be ascribed by one of ordinary skill within the art.

### DEFINITIONS

“Educational Database” (ED) is a collection of medical facts in digital format with analytic functional capability to access, categorize, sort, select, and report medical facts within the database. Educational Database may be considered educational information including CME data and CME credit data.

“Electronic Medical Record” (EMR) is a medical record in digital format that contains demographic and clinical data (health information) which, with appropriate software, has analytic functional capability to sort, list, add, or conduct other statistical analyses or reporting of the data.

“E-Prescription” is a medical prescription sent by a healthcare professional electronically to a patient's pharmacy of choice, usually from the patient's point of care.

“Continuing Medical Education” or (CME) is education provided after an individual completes a formal training course for a specific career, profession, or job, generally for maintaining proficiency.

“Healthcare Professionals” (HCP) are individuals who completed a course, training program, or degree program in the medical profession, and who have been licensed by a governmental agency and/or who have been certified or approved by a medical professional organization to provide medical care (Examples include but are not limited to physicians, nurses, pharmacists, nursing assistants, dental assistants, dentists, medical laboratory technicians, respiratory therapists, occupational therapists, physical therapists, etc.)

“Healthcare Professional Scope of Practice” is the level and medical area of expertise a healthcare professional has received from his/her education/training.

The “POCAME” system means the Point Of Care Automated Continuing Medical Education system.

“Point of Care Treatment” (or POCT) means treatment that is undertaken using small, handheld devices, sensors, test kits, or other such instruments (e.g., blood glucose meter). Cheaper and more capable POCT devices have expanded the use of POCT by making it cost-effective for use in the treatment of many diseases. (See, Davis, D., et al., “Impact of Formal Continuing Medical Education: Do Conferences, Workshops, Rounds, and Other Traditional Continuing Education Activities Change Physician Behavior or Health Care Outcomes?” JAMA, September 1999; 282: 867-874).

“Treatment Algorithm” is a digital information decision sequence or tree containing sequential medical treatments to reach a defined treatment goal.

“Treatment Outcome” is a measureable clinical value, such as weight, pulse, blood pressure, laboratory value, symptom, or physical finding. EMR data is evidence of a Treatment Outcome and may be a value, such as weight, pulse, blood pressure, laboratory value, symptom, or physical finding.

“Treatment Outcome Goal” or “Treatment Goal” is a defined optimal clinical value or datum, such as weight, pulse, blood pressure, laboratory value, symptom, or physical finding.

The POCAME system is a process, system, and articles of manufacture, aspects of embodiments of which are intended to provide point of care, patient-centric, learner-specific, automated or manual CME from an ED. The POCAME system's ED or educational database contains evidence-based disease state information and treatment algorithms. The POCAME system provides CME information in response to either an automated inquiry from an EMR, a manual inquiry based on EMR or a disease state, or even an inquiry based on a hypothetical or theoretical patient.

The POCAME system provides an integrated treatment information and CME delivery system for HCPs that overcomes the problems with current CME delivery approaches, while incorporating or addressing the aforementioned nine elements of an improved CME system.

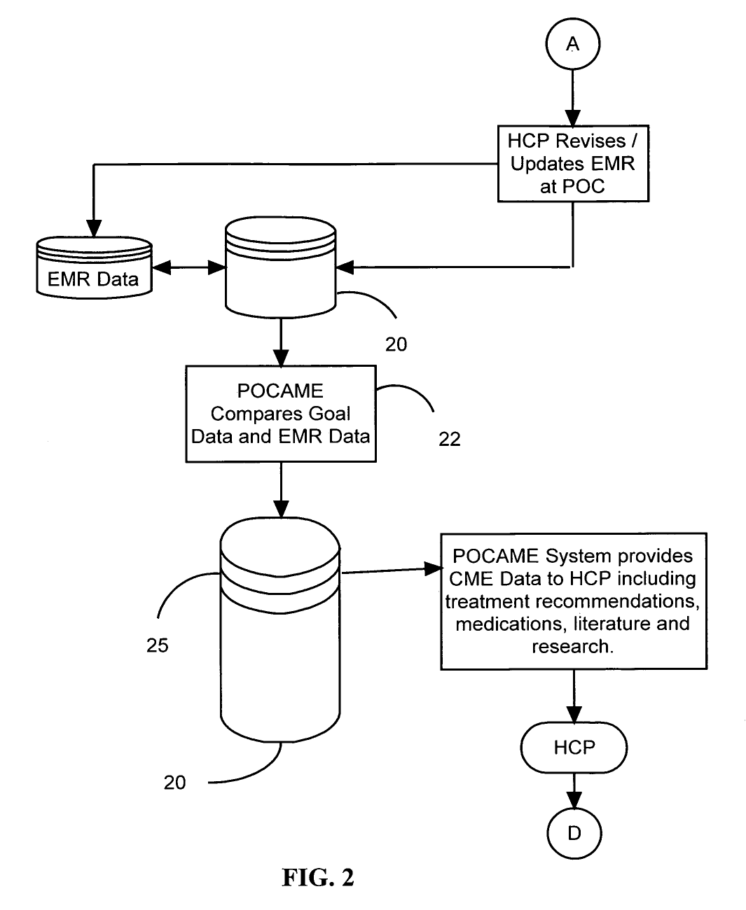

The POCAME system is preferably integrated with EMRs to identify the HCP's current CME needs, which are based on gaps or short falls between the HCP's patient's EMR data or current treatment outcome and optimal treatment outcome goals (e.g., a hypertensive patient's blood pressure compared to a goal blood pressure). When a gap or treatment delta is identified, the POCAME system provides evidenced-based treatment recommendations and information from the POCAME system's ED that is specific or tailored to the patient's concomitant diseases, end organ disease(s), allergies, current medications, etc. The HCP may also manually enter a request for CME based on a theoretical patient or a disease state that is within the POCAME system's ED (FIG. 2).

Following the HCP's receipt of the patient specific CME data and the HCP making a treatment decision, the POCAME system may send an electronic CME evaluation form, if desired, to the HCP concerning the information that has been provided. Upon completion and submission of the CME evaluation form back to the POCAME system by the HCP, the POCAME system issues and tracks Category 1 CME credit to the HCP. The HCP may receive a certificate of earned CME at the time of the encounter or periodically.

To measure the effectiveness of the CME provided, the POCAME system (periodically at the direction of the HCP or a POCAME manager) may assess the clinical outcome(s) or EMR data of a patient for whom the CME information was sought, and may assess the change in therapy or treatment, if any, that may have resulted from the CME, along with an analysis and report of any new E-prescriptions and/or treatments recommended by the POCAME system that were subsequently ordered by the HCP. These outcomes may also be compared to those of peer groups of the HCP, or to national standards of care.

The POCAME system is well suited to take advantage of POCT. Major benefits may be obtained when the data collected from a POCT sensor is made available within an EMR. For the purposes herein, “sensor” denotes a device capable of collecting or receiving data that may be provided to an EMR. Collected EMR data can be shared instantaneously with other HCPs through a software interface and computer networks. A reduction in morbidity and mortality has been associated with the use of POCT and EMRs. (See Slawson, David C., Josiah Macy, Jr. Foundation, Continuing Education in the Health Professions: Improving Healthcare through Lifelong Learning 94 (2007), /http://www.josiahmacyfoundation.org/documents/pub_ContEd_in HealthProf.pdf/. In fact, in some locations, POCT has been endorsed as a normal standard of care. See Moore, D. E., Josiah Macy, Jr. Foundation, Continuing Education in the Health Professions: Improving Healthcare through Lifelong Learning 38, 45, 51-52, 94 (2007), /http://www.josiahmacyfoundation.org/documents/pub_ContEd_in HealthProf.pdf/.

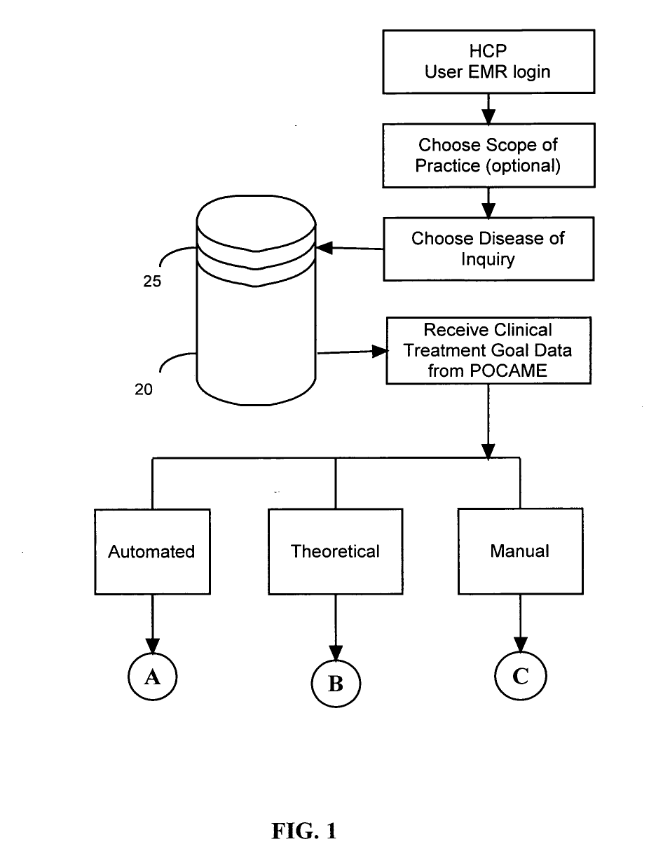

With reference to the figures, FIG. 1 is a view of the operation of an embodiment of the POCAME system [20] and its automated CME/EMR functions. In moving through the steps, the typical first step is HCP's initial access by user login. The HCP may sign on to the POCAME system [20] with a password for secure access, and preferably, though not necessarily, may choose a scope of practice that could be used within the Educational Database [25] to facilitate searching CME. The HCP may then choose a disease of inquiry, optionally with a disease state(s) for which CME information for a particular patient or group of patients is needed. The POCAME system [20] may then provide treatment goal data to the HCP for review (for example, blood pressure treatment goal of a patient with hypertension, etc). The POCAME system [20] treatment goal data may be consensus-derived clinical guidelines that are updated periodically by the POCAME system [20]. Optionally, the HCP may accept or enter alternative patient specific treatment goals. The HCP may also review the POCAME system's [20] Treatment Algorithm for any disease state. The HCP may then review and choose one of the following system operational pathways or modes: [A] an automated pathway, in which the HCP inputs a patient's actual EMR data, the default POCAME system [20] pathway; [B] the hypothetical or theoretical patient pathway; or [C] a manual generic disease state pathway.

FIG. 2 is an illustration of the automated pathway [A] with a patient specific, POC inquiry. The HCP may develop and/or access an individual patient's data in an EMR to which the POCAME system [20] is connected, in communication with, or otherwise integrated so as to be able to receive a relevant portion of data within the EMR. The HCP may enter any new patient EMR data or information for the current patient encounter into the EMR, and send it to the POCAME system [20]. Alternatively, this data may be periodically updated, or received from a POC sensor (such as a pulse monitor or EEG) (not shown) in communication with a processor of the POCAME system [20]. Data entry may include any new treatment outcomes or EMR data. The EMR links with the POCAME system [20] using the patient's current EMR data (e.g., treatment outcome) for a selected disease state of inquiry. Whether the HCP sends (as in an [ENTER] being pressed) the EMR data or allows the POCAME system [20] to interrogate or pull the EMR data as it is being inputted, the POCAME system [20] calculates the treatment delta [22] or gap between any current (or most recent) patient treatment outcome (i.e., EMR data) and the same treatment outcome goal(s) data. In other words, the treatment delta [22] may be a difference between EMR data and clinical treatment goal data corresponding relevant data to a disease of inquiry. If a treatment delta [22] or gap exists, the POCAME system [20] provides CME information or content (i.e., CME data) from the POCAME system [20] Educational Database [25] identifying the gap(s) and methodologies to close the treatment delta [22] identified; this may be in the form of a POCAME system [20] report. Such a report may optionally include a list of additional treatments and/or medications (e.g. E-Prescriptions) and a summary, or link to a summary, of medical literature that supports the recommended treatments. The HCP may then choose to prescribe additional treatment or medications (or not to prescribe) to close the gap or treatment delta [22]. The HCP may also locally save the report for later review. Optionally, CME may be locally saved in a variety of educational formats, including but not limited to written material, audio, video, digital, and simulated educational instruction.

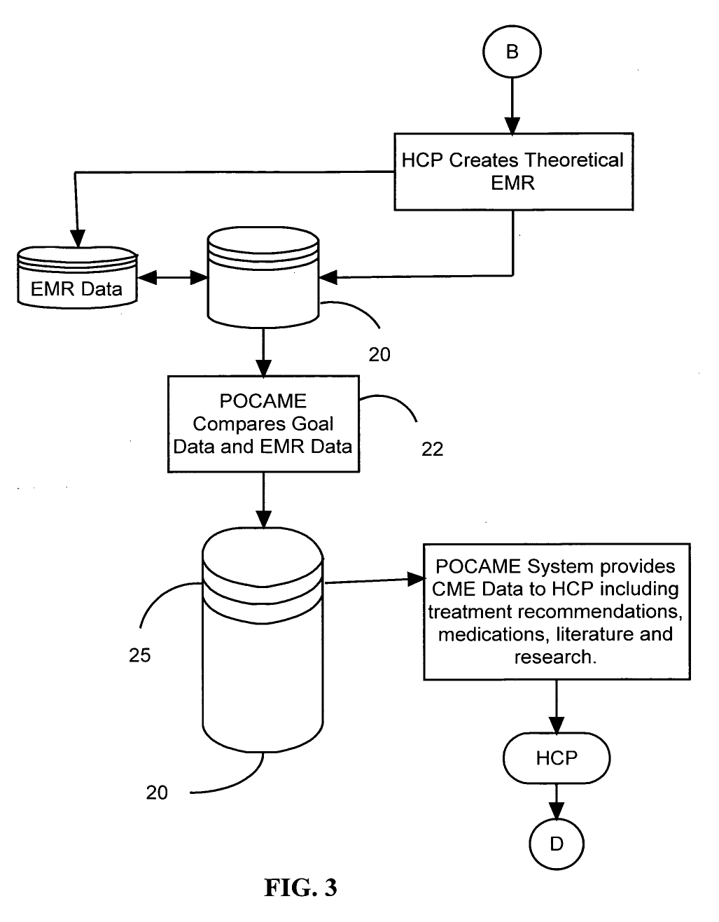

FIG. 3 is an illustration of an embodiment of a theoretical patient inquiry [B]. The HCP signs-on to the POCAME system [20] in a manner similar to that described above in reference to FIG. 1. In this pathway, the HCP enters the hypothetical clinical characteristics (i.e., data corresponding to a hypothetical EMR) of a theoretical patient including treatment outcomes. The POCAME system [20] may then calculate the treatment delta [22] or gap(s) between any current (or most recent) hypothetical patient treatment outcome data (i.e., corresponding to EMR data) and the treatment goal data. If a treatment delta [22] or gap exists, the POCAME system [20] provides CME; this may be in the form of a POCAME system's [20] report from the Educational Database [25] to close the treatment gap [22]. This report may include a list of additional treatments and/or medications and a summary of the medical literature or a link to a summary that supports the recommended treatments. If desired, the HCP can locally save the report information for later review.

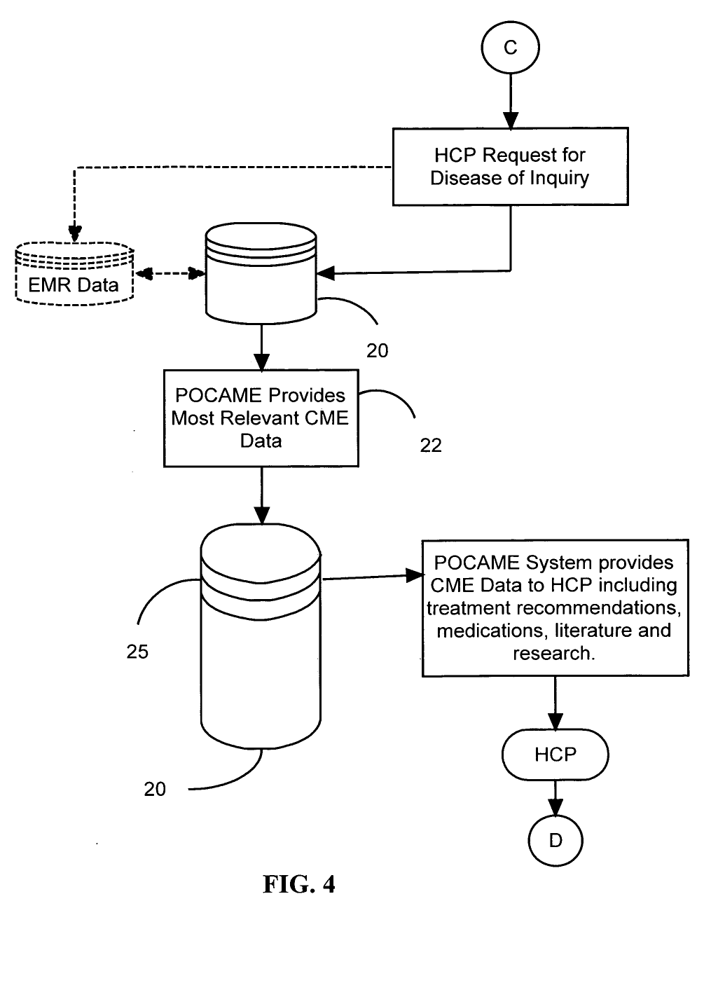

FIG. 4 is an illustration of an embodiment of a manual pathway inquiry [C]. The HCP signs-on to the POCAME system [20] in a manner similar to that described above in reference to FIG. 1. Similarly the HCP may choose a disease of inquiry, preferably with a Disease State Inquiry Screen, for example. The POCAME system [20] selects relevant CME and send a report which provides disease state CME data or information from the Educational Database [25]. The report optionally may include a summary of the supporting medical literature or a link to a summary. If desired, the HCP may locally save the report information for later review.

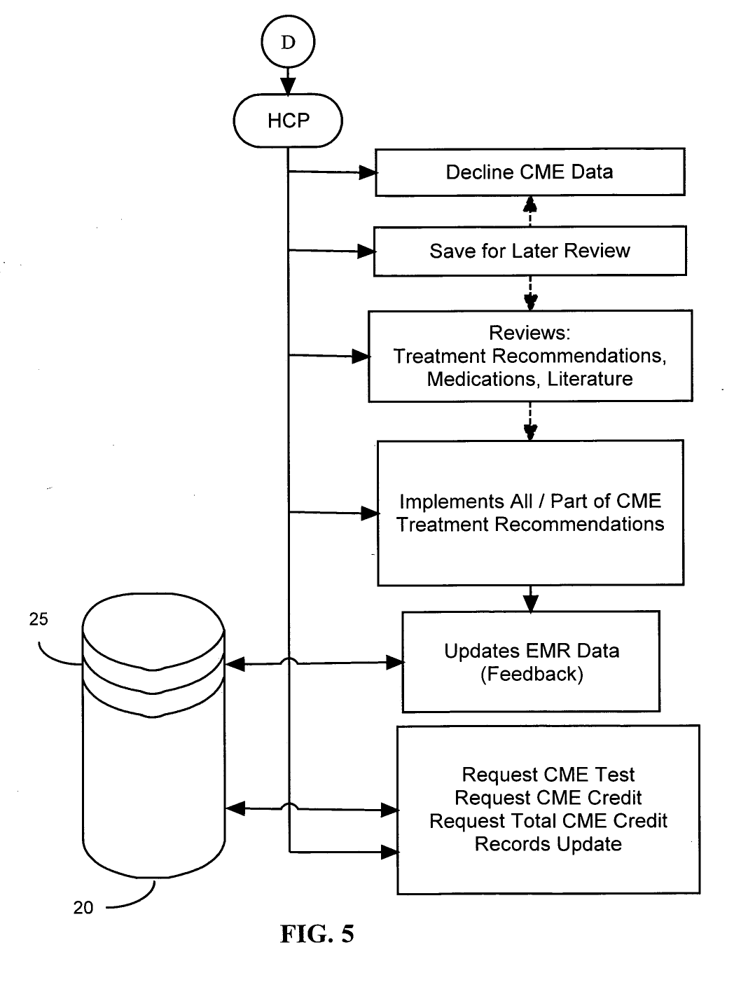

FIG. 5 is an illustration of the types of post-CME HCP response [D], including, for example, information and reports that may be generated for review by the HCP from any of a variety of HCP inquiries. The data may include additional treatment recommendations, medications, literature, published research or the like. The HCP may respond at least partially by implementing treatment of a real patient, or used in conjunction with a theoretical patient for a CME learning exercise. The HCP may also query the POCAME system [20] as to an appropriate examination for testing CME knowledge, number of CME credits earned in that session, or CME credits earned over a period of time.

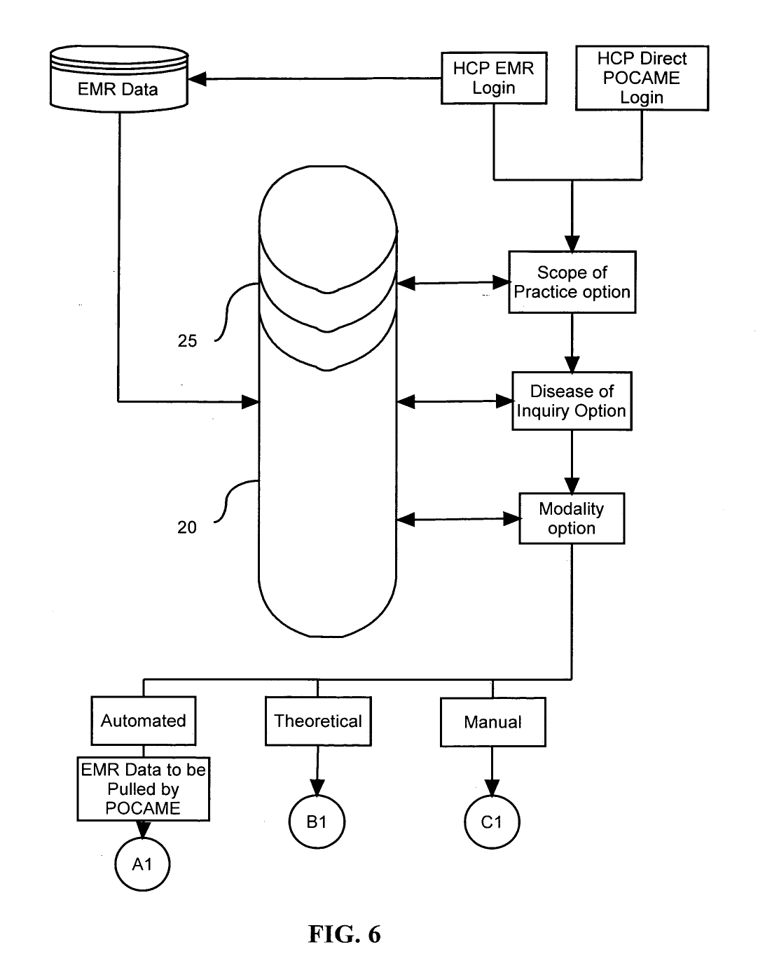

With reference to the figures, FIG. 6 is an alternate view of the operation of an embodiment of the POCAME system [20] and its automated CME/EMR functions. In moving through the steps, the typical first step is HCP's initial access by user EMR login through computer device at the POC or remotely. This method also links the HCP and the POCAME system [20] with an individual EMR and the collective EMR database. Alternately the HCP may log directly into the POCAME system [20] for general or broad CME references. The HCP may sign on to the POCAME system [20] in either method with a password for secure access, and preferably, though not necessarily, may choose a scope of practice that could be used within the Educational Database [25] to facilitate searching CME. The HCP may then choose a disease of inquiry, optionally with a disease state(s) for which CME information for a particular patient or group of patients is needed. The HCP may then choose a modality shown as options [A1, B1 and C1] respectively. The POCAME system [20] may then provide treatment goal data to the HCP for review (for example, blood pressure treatment goal of a patient with hypertension, etc). The POCAME system [20] treatment goal data may be consensus-derived clinical guidelines that are updated periodically by the POCAME system [20]. Optionally, the HCP may accept or enter alternative patient specific treatment goals. The HCP may also review the POCAME system's [20] Treatment Algorithm for any disease state. The HCP may then review and choose one of the following system operational pathways or modes: [A1] an automated pathway, in which the HCP inputs a patient's actual EMR data, the default POCAME system [20] pathway; [B1] the hypothetical or theoretical patient pathway; or [C1] a manual generic disease state pathway.

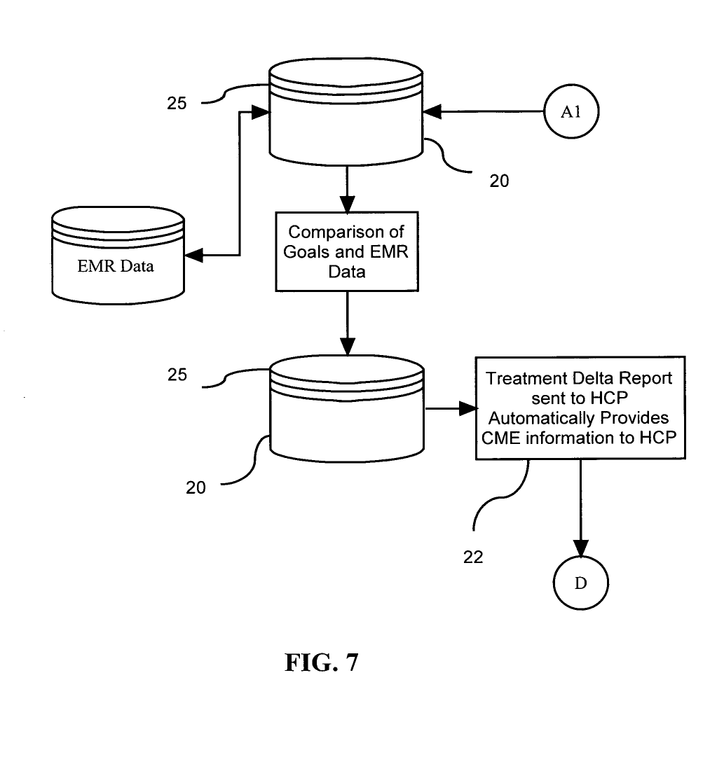

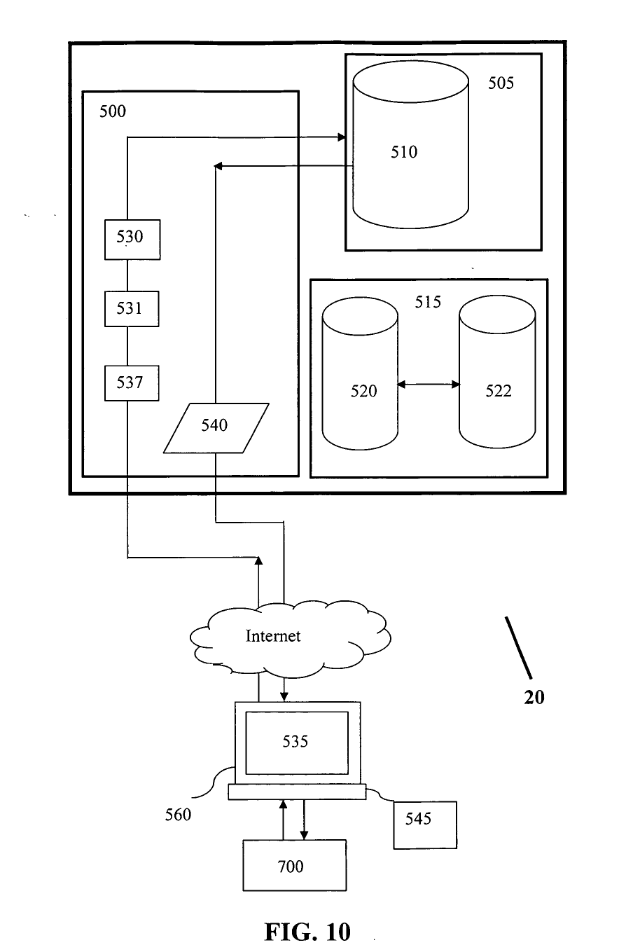

FIG. 7 is an illustration of the automated pathway [A1] with a patient specific, POC inquiry. The HCP may develop and/or access an individual patient's data in an EMR to which the POCAME system [20] is connected, in communication with, or otherwise integrated so as to be able to receive a relevant portion of data within the EMR. The HCP may enter any new patient EMR data or information for the current patient encounter into the EMR. In the automatic mode, preferably the POCAME system [20] pulls EMR data relevant to the disease of inquiry. Preferably, this data may be periodically updated, or received from a POC sensor(s) (such as a pulse monitor or EEG) (FIG. 10-12) in communication with a processor of the POCAME system [20]. Data entry may include any new treatment outcomes or other EMR data. Thus, the EMR links with the POCAME system [20] using the patient's current EMR data (e.g., treatment outcome) for a selected disease state of inquiry. Whether the HCP sends (as in an [ENTER] being pressed) the EMR data or allows the POCAME system [20] to interrogate or pull the EMR data as it is being inputted, the POCAME system [20] calculates the treatment delta [22] or gap between any current (or most recent) patient treatment outcome (i.e., EMR data) and the same treatment outcome goal(s) data. In other words, the treatment delta [22] may be a difference between EMR data and clinical treatment goal data corresponding relevant data to a disease of inquiry. If a treatment delta [22] or gap exists, the POCAME system [20] provides CME information or content (i.e., CME data) from the POCAME system [20] Educational Database [25] identifying the gap(s) and methodologies to close the treatment delta [22] identified; this may be in the form of a POCAME system [20] report. Such a report may optionally include a list of additional treatments and/or medications (e.g. E-Prescriptions) and a summary, or link to a summary, of medical literature that supports the recommended treatments. The HCP may then choose to prescribe additional treatment or medications (or not to prescribe) to close the gap or treatment delta [22]. The HCP may also locally save the report for later review. Optionally, CME may be locally saved in a variety of educational formats, including but not limited to written material, audio, video, digital, and simulated educational instruction. The HCP then chooses the options as shown in FIG. 5 [D].

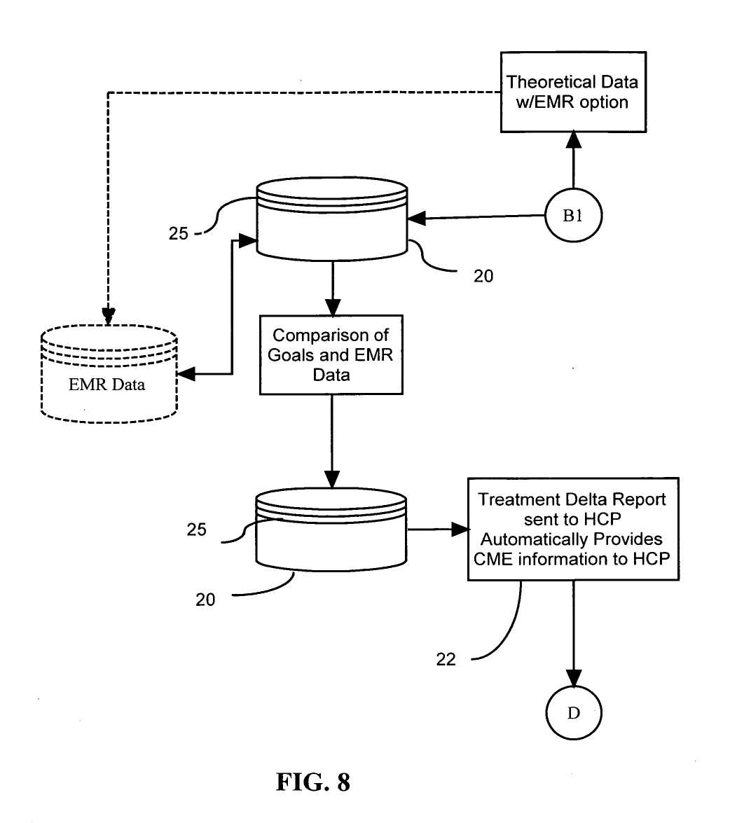

FIG. 8 is an illustration of an embodiment of a theoretical patient inquiry [B1]. The HCP signs-on to the POCAME system [20] in a manner similar to that described above in reference to FIG. 6. In this pathway, the HCP enters the hypothetical clinical characteristics (i.e., data corresponding to a hypothetical EMR) of a theoretical patient including treatment outcomes. The POCAME system [20] may then calculate the treatment delta [22] or gap(s) between any current (or most recent) hypothetical patient treatment outcome data (i.e., corresponding to EMR data) and the treatment goal data. If a treatment delta [22] or gap exists, the POCAME system [20] provides CME data; this may be in the form of a POCAME system's [20] report from the Educational Database [25] to close the treatment gap [22]. This report may include a list of additional treatments and/or medications and a summary of the medical literature or a link to a summary that supports the recommended treatments. If desired, the HCP can locally save the report information for later review. The HCP then chooses the options as shown in FIG. 5 [D].

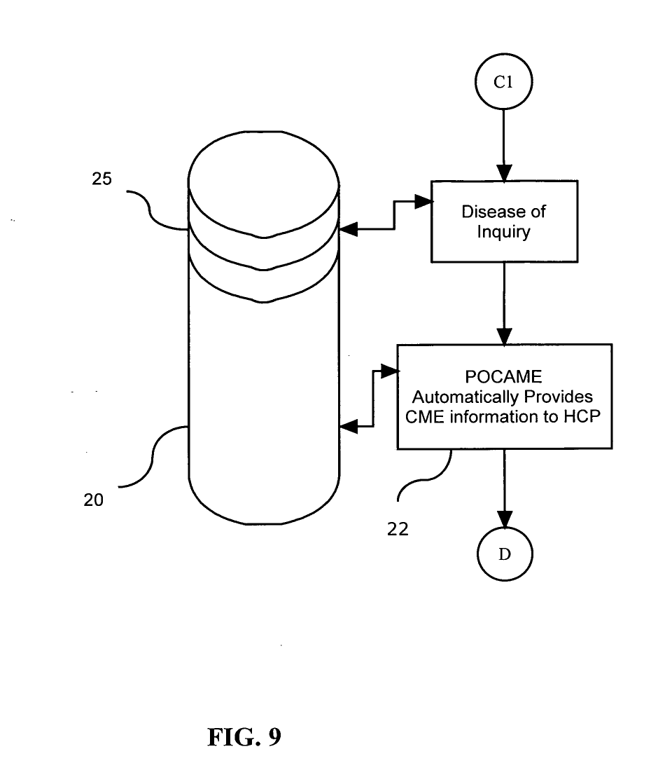

FIG. 9 is an illustration of an embodiment of a manual pathway inquiry [C1]. The HCP signs-on to the POCAME system [20] in a manner similar to that described above in reference to FIG. 6. Similarly the HCP may choose a disease of inquiry, preferably with a Disease State Inquiry Screen, for example. The POCAME system [20] selects relevant CME data and send a report which provides disease state CME data or information from the Educational Database [25]. The report optionally may include a summary of the supporting medical literature or a link to a summary. If desired, the HCP may locally save the report information for later review. The HCP then chooses the options as shown in FIG. 5 [D].

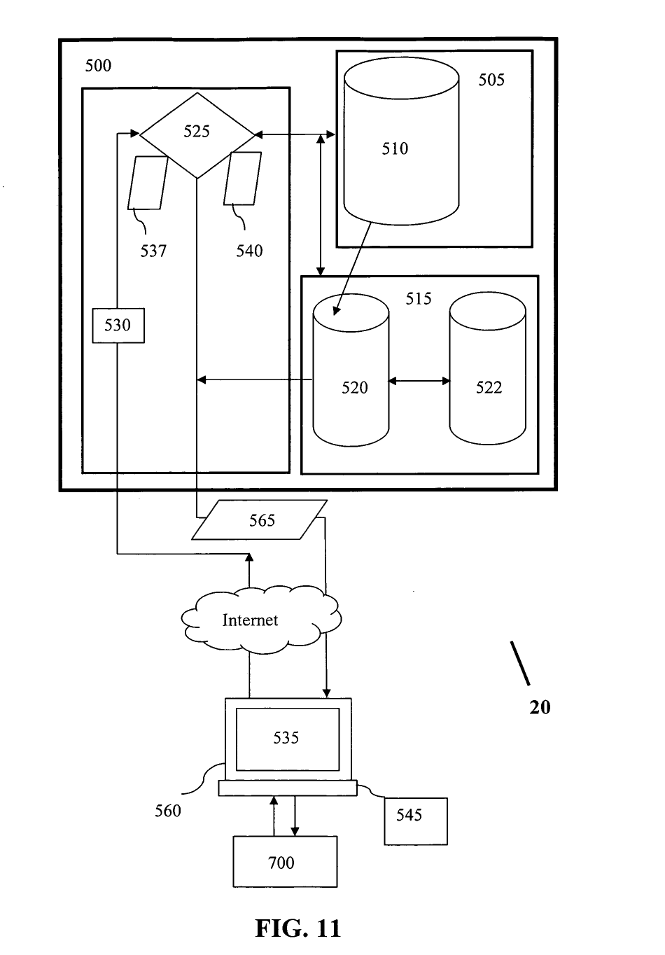

FIGS. 10 and 11 show the POCAME system [20] layout and information flow at different points in the automatic mode. The other modes would include portions of the illustrated mode, with some variations as discussed above. These figures display an embodiment with remote access via the internet; however, other embodiments of the system may be hosted locally on a single device, within one or more local networks, etc., as may be applicable.

In FIG. 10, HCP user [700] at HCP computer [560] selects a condition or disease of inquiry [530] (and optionally a scope of practice) and makes a pathway or mode choice [531], which are transmitted to processor [500]. Processor [500] is coupled with a treatment goal memory [505] for storing clinical treatment goal data [510] associated with at least one or more diseases. Preferably, but not necessarily, treatment goal data portion [540] matching the disease of inquiry may be provided to the HCP user [700] for review. The HCP user [700] selects the patient with corresponding EMR data [535], such that at least an EMR data portion [537] relevant to the condition or disease of inquiry is sent to processor [500]. Additionally, there is an education memory [515] having CME data [520] and a CME credit database [522].

FIG. 11 shows the information flow in the POCAME system [20], with follow on steps illustrated. Processor [500] is coupled with an educational memory [515] for storing CME data [520] associated with at least one or more disease. A treatment delta [525] is to be generated by service software as a difference between clinical treatment goal data [540] and corresponding EMR data portion [537] relevant to a disease of inquiry [530]. The processor is adapted to receive an HCP user's [700] selection of a disease of inquiry [530] and EMR data portion [537] relevant to the disease of inquiry. Processor [500] has service software when executed that is able to (i) query the treatment goal memory [505] for treatment goal data portion [540] matching the disease of inquiry [530], (ii) compare the disease treatment goal data portion [540] with the EMR data portion [537] to determine a treatment delta [525]; (iii) select CME data portion [565] from educational memory [515] based on the disease of inquiry [530] and the treatment delta [525], and (iv) to provide the CME data portion [565] to the HCP user [700].

EMR data portion [537] may correspond to patient data from at least one point of care sensor(s) [545]. The point of care sensor(s) [545] may sense and transmit data patient data directly into the EMR data [535], which may automatically be provided directly to the processor [500]. The HCP user [700] may be located at the point of care or remotely, such as at a branch office.

Additionally the POCAME system [20] may optionally perform various analyses of HCP specific CME activity effectiveness. The HCP [700] or a POCAME system [20] internal system manager may select EMR data [537] within the POCAME system [20] or query addition data from an integrated EMR [535] for analysis of treatment outcomes and/or effectiveness in changing the HCP's practice actions (e.g., prescribed treatments/medications) or that patient's treatment outcomes. At a later time the HCP [700] or POCAME system [20] system manager may optionally select or enter any additional treatment outcome comparator values and/or may select a time period from the date of any POCAME system [500] reports forward for analysis, or at a particular time.

Other optional analyses may be directed to desired POCAME system [20] outcomes. The following are examples of three, but not all, potential outcome analyses (e.g., a CME Outcome Analysis Report) that may be desirable for certain embodiments: (i) the POCAME system [20] may calculate the changes in individual or group of patients' treatment outcomes over time, and may report this; (ii) the POCAME system [20] may report a comparison of an individual or group of patients' treatment outcomes compared to a specified comparator group of treatment outcomes over a specified time period; and (iii) the POCAME system [20] may, for example, report a list of the treatments and medication(s) that were recommended in the POCAME system [20] report and the E-prescriptions and treatments that were ordered by a HCP [700] for an individual or a group of patients over a specified period of time, and may report this.

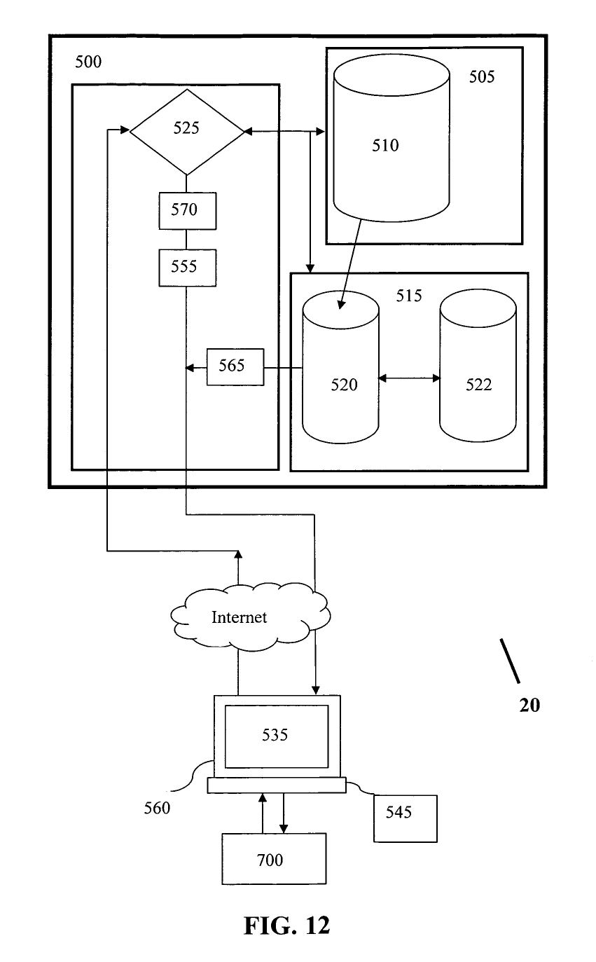

As shown in FIG. 12, additional information may be requested from the HCP user [700] in regards to CME credit. After receiving and reviewing the POCAME system [20] CME data portion [565] (FIG. 11), the HCP [700] has the option of electronically requesting CME credit via the POCAME system [20]. For example, embodiments of the POCAME system [20] may provide graphic user interface at computer [560] (e.g., a CME Report Screen) to assist the HCP [700] in sending the request. Optionally, the POCAME system [20] may also provide to the HCP [700], upon request, a graphic user interface for testing, post testing, and CME evaluation (e.g., a CME Evaluation Screen (Form)). The transmitted evaluation and post test may contain an assessment of the CME educational information value, while a post test may assess any change in HCP's [700] knowledge or competency. The HCP [700] may complete a CME evaluation and post test, and may send them, electronically to a POCAME system [20] CME credit database [522]. If the POCAME system [20] CME evaluation and post test have a complete set of responses, then they may be evaluated by the POCAME system [20]. Should the HCP [700] score 80% or greater correct answers, for example, then the POCAME system [20] may send (1) an electronic message to HCP of earned CME credit; and (2) a report to the POCAME system [20] CME credit database of the minutes of CME earned by the HCP user [700]. Educational memory [515] may thus host CME credit database [522], which may retain access information, data circulated to and from the HCP user [700], and the treatment modalities or CME data portion [565] recommended from the CME data [520]. CME credits of an HCP user [700] may be reported, upon inquiry, to the HCP user [700] via computer [560] from the CME credit database [522]. Responses may be electronic or paper, in the form of a certificate [555], or a CME credit report [570] which may include information such as an overall CME credit history record, literature reviewed, test scores, and evaluations. Additionally the HCP [700] may request a summary report from the POCAME system [20] of total earned CME credits over a specified period of time.

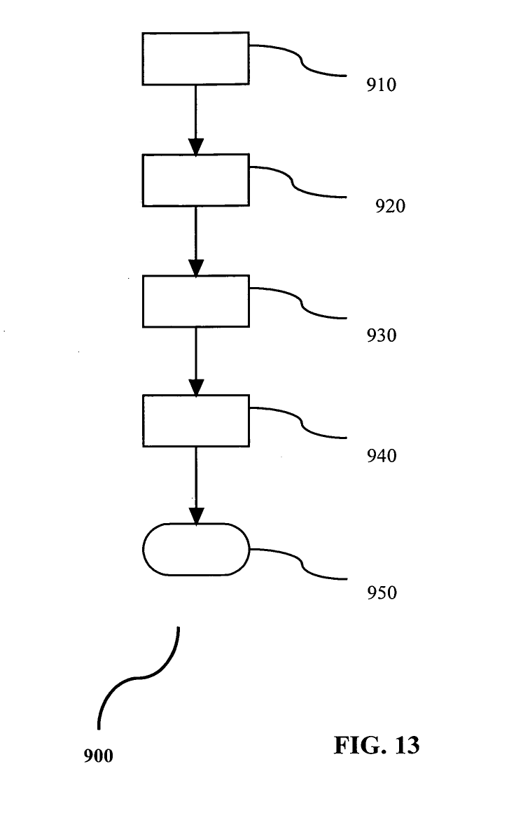

FIG. 13 illustrates the process [800] for the integrated education of HCP's and treatment recommendations for patients. This process includes a first step [910] of storing in an educational memory CME data associated with at least one or more diseases and a treatment delta, wherein the treatment delta is a difference between clinical treatment goal data and corresponding data relevant to a disease of inquiry, a second step [920] of receiving an HCP user's selection of a disease inquiry and EMR data relevant to such disease of inquiry; the third step [930] of querying the treatment goal data for a disease matching the disease of inquiry, comparing the matching treatment goal data with the EMR data to determine a treatment delta; the fourth step [940] of selecting CME data based on the disease of inquiry and the treatment delta; and the fifth step [950] of providing CME data to the HCP user.

Thus, in reference to the figures, an embodiment of the integrated continuing medical education and treatment system supporting the foregoing may include a processor [500] coupled with a treatment goal memory [505] for storing clinical treatment goal data [510] associated with at least one or more disease, and also coupled with an CME educational memory [515] for storing published literature and education and the data associated with at least one or more disease and a treatment delta [525]. This processor [500] may be adapted to receive an HCP user's [700] inquiry of a disease of and EMR data portion [537] relevant to any disease of inquiry [530]. Service software may be associated with or executed on the processor [500] and configured (i) to query one or more clinical treatment goal data [510] for a disease matching the disease of inquiry [530], (ii) to compare the matching treatment goal data [510] with the EMR data portion [537] to determine a treatment delta [525], (iii) to select CME data based on the disease of inquiry [530] and the treatment delta [525], and (iv) to provide the CME data [520] to the HCP user [700].

Another embodiment of the process for the integrated the education of HCPs and treatment may involve the following steps: storing in a treatment goal memory [505] specific clinical treatment goal data [510] associated with at least one or more disease; storing in an educational memory [515] CME data [520] associated with at least one or more diseases and a treatment delta [525], wherein the treatment delta [525] is a difference between clinical treatment goal data [510] and corresponding data relevant to a disease of inquiry [530]; receiving an HCP user's [700] inquiry of a disease of concern and EMR data portion [537] relevant to such disease of inquiry [530]; querying the treatment goal data [510] for a disease matching the disease of inquiry [530], comparing the matching treatment goal data [510] with the EMR data portion [537] to determine a treatment delta [525]; selecting CME data [520] based on an optimal treatment/response for the disease of inquiry [530] and the treatment delta [525]; and providing CME data [520] to educate the HCP user [700].

A further embodiment may be an article of manufacture or computer readable medium storing a computer program which provides continuing medical education in a variety of educational mediums, including but not limited to written material, audio, video, digital, and simulated educational formats. Such computer readable media may be adapted to the desired delivery approach, such as CD-ROM, interne download, portable memory, flash drives, etc. The computer readable media may involve a first code segment which, when executed on a computer stores in a treatment goal memory [505] clinical treatment goal data [510] associated with at least one or more diseases; a second code segment which, when executed on a computer [560] stores in an educational memory [515] CME data [520] associated with at least one or more diseases and a treatment delta [525], wherein the treatment delta [525] is a difference between treatment goal data [510] and corresponding data relevant to a disease of inquiry [530]; a third code segment which, when executed on a computer [560] accepts an HCP user's [700] inquiry of a disease [530] and EMR data portion [537] relevant to such a disease of inquiry [530]; a fourth code segment which, when executed on a computer [560] queries the treatment goal data [510] for a disease matching the disease of inquiry [530] and compares the matching treatment goal data [510] with the EMR data portion [537] to determine a treatment delta [525]; a fifth code segment which, when executed on a computer [560] selects CME data [520] for educating the HCP user [700] based on the disease of inquiry [530] and the treatment delta [525]; a sixth code segment which, when executed on a computer [560] provides the CME data [520] from the educational memory [515] to the HCP user [700]; and a seventh code segment which, when executed on a computer [560] provides an evaluation of the CME data [520] that was provided by the educational memory [515] to the HCP user [700]. The treatment delta [525] and CME data [520] may also be transmitted to and stored in a CME credit database [522]. The CME credit database [522] retains the treatment delta [525] and CME data [520] or CME data portion [565] sent to the HCP user [700] and compares any new treatment to what was recommended by the POCAME system [20]. In addition, if the recommendations for CME were followed, the HCP user [700] may be allowed a certain number of continuing medical education credits. The CME credit database [522] may then generate the continuing medical education credits on a CME credit report [570] and/or a certificate [555] for that HCP user [700].

The following are examples of potential embodiments of POCAME system Reports. Of course, a wide variety of reports are possible, with a wide variety of fields or information as may be desired, depending on the implementation and particulars of the application.

A first report from the POCAME system may be an Automated Patient Specific POC Inquiry. This report may provide the treatment delta or gap between EMR data for a treatment outcome and the treatment goal data (as an example, for hypertension, the difference between the treatment outcome goal blood pressure and the patient's blood pressure at the most recent encounter available within the EMR).

If the treatment delta between the EMR data of a treatment outcome and the treatment goal is greater than an amount defined or chosen within the POCAME system (n. b., an amount that may account for the variability of measurement), then the report may provide POCT recommendations from the POCAME system Treatment Algorithm to reduce the treatment delta and close the gap. Recommended POCT may be specific to the patient's concomitant disease state(s), end organ disease(s), allergies, and current medications, for example.

This first report allows the HCP to choose and to send an electronic communication message to provide any recommended additional treatments and/or medications, including E-prescriptions when appropriate. The first report may also provide a summary of the medical literature from the POCAME system CME Content Educational Database that supports the recommended treatments or medications. Hyperlinks may be provided to electronically available source documents for access to the medical information. An HCP may print or save the medical literature information for later review. The first report may provide an opportunity for an HCP to request CME credit for the POCAME system CME information.

In a second report the POCAME system may generate a Manual Theoretical Patient Inquiry Report. This report may provide the treatment delta or gap between the theoretical patient EMR data associated with a treatment outcome and the treatment goal data (as an example, for hypertension, the difference between the treatment outcome goal blood pressure and the patient's blood pressure at the most recent encounter available within the EMR).

If the treatment delta is greater than an amount defined or set within the POCAME system (n. b., an amount that may account for the variability of the measurement), the report may provide treatment recommendations or POCT from the POCAME system Treatment Algorithm to close the gap or treatment delta. Recommended POCTs may be specific to the theoretical patient's concomitant disease state(s), end organ disease(s), allergies, and current medications, etc.

The second report may provide a summary of the medical literature from the POCAME system CME Content Educational Database that supports the recommended treatments or medications. Hyperlinks may be provided to source documents for the medical information. An HCP may print or save the medical literature information for later review. The second report provides an opportunity for the HCP to request CME credit for the POCAME system CME information.

A third report may be a Manual Disease State Inquiry. This report may provide a summary of medical literature from the POCAME system CME Content Educational Database for the disease state requested by an HCP. Hyperlinks may be provided to source documents for the medical information. The HCP may print or save the medical information for a later review. The third report also provides an opportunity for the HCP to request CME credit for the POCAME system CME information.

Potential fields may include a CME Evaluation Screen (Form) having elements or questions such as the following: (i) “Did the information answer your Point of Care question?” (ii) “Did you change your care based on the CME information?” (iii) “Did you perceive any commercial bias in the CME information provided? If so, what?” (iv) “Please provide any additional comments.”

A fourth report may be an: Earned CME Report. This report may provide to the HCP a report of the CME credit that he/she has earned through POCAME for an individual patient or a summary of all earned credits. An Analysis of HCP Specific Continuing Medical Education Effectiveness may be generated. This report may provide (i) a summary from the POCAME system and the related EMR of the changes in the patient's treatment outcome EMR data between the date of the POCAME system CME Report and the patient's last clinic encounter; (ii) from the POCAME system a summary of the patient(s)' last treatment outcome EMR data and a defined set of optimal peer comparable treatment goal data; and (iii) a POCAME system list of treatments and medication(s) that were recommended in the POCAME system CME Report(s) and the subsequent treatments and E-prescriptions that were ordered since the date of the POCAME system CME Report.

In summary the present disclosure is an integrated continuing medical education and treatment system, having a processor coupled with a treatment goal memory for storing clinical treatment goal data associated with at least one or more disease, and also coupled with an educational memory for storing CME data associated with at least one or more disease and a treatment delta wherein the treatment delta is a difference between clinical treatment goal data and corresponding data relevant to a disease of inquiry. The processor is adapted to receive an HCP user's selection of a disease of inquiry and EMR data relevant to any disease of inquiry. The processor has service software executable on the processor and configured (i) to query one or more clinical treatment goal data for a disease matching the disease of inquiry, (ii) comparing the matching treatment goal data with the EMR data to determine a treatment delta, (iii) to select CME data based on the disease of inquiry and the treatment delta, and (iv) to provide the CME data to the HCP user.

A functional component of the integrated system is a process for the integrated education of HCPs and treatment, having stored in a treatment goal memory, clinical treatment goal data associated with at least one or more disease. Storage in an educational memory, CME data associated with at least one or more diseases and a treatment delta, wherein the treatment delta is a difference between clinical treatment goal data and corresponding data relevant to a disease of inquiry. A HCP user's selection of a disease of inquiry and EMR data relevant to such disease of inquiry is received where the treatment goal data is queried for a disease matching the disease of inquiry. The query is then compared to the matching treatment goal data with the EMR data to determine a treatment delta. The CME data is selected based on the disease of inquiry and the treatment delta where the CME data is provided to the HCP user.

Output from the system may include an article of manufacture, which is a computer readable medium having stored therein a computer program for providing continuing medical education in a variety of educational mediums. Included in the medium is, but not limited to, written material, audio, video, digital, and simulated educational formats. The medium has a first code segment which, when executed on a computer, stores in a treatment goal memory clinical treatment goal level data associated with at least one or more diseases. A second code segment which, when executed on a computer stores in an education memory location CME data associated with at least one or more diseases and a treatment delta, wherein the treatment delta is a difference between clinical treatment goal data and corresponding data relevant to a disease of inquiry. A third code segment which, when executed on a computer accepts an HCP user's selection of a disease of inquiry and EMR data relevant to such a disease of inquiry. A fourth code segment which, when executed on a computer queries the treatment goal data for a disease matching the disease of inquiry and compares the matching treatment goal data with the EMR data to determine a treatment delta. A fifth code segment which, when executed on a computer selects CME data based on the disease of inquiry and the treatment delta. A sixth code segment which, when executed on a computer provides the CME data to the HCP user; and a seventh code segment which, when executed on a computer provides an evaluation of the CME data that was provided to the HCP.

The present invention extends to a system and process for integrating the education of HCPs and treatment This process involves the steps of (i) storing in a treatment goal memory clinical treatment goal data associated with at least one or more disease; (ii) storing in an educational memory CME data associated with at least one or more diseases and a treatment delta, wherein the treatment delta is a difference between clinical treatment goal data and corresponding data relevant to a disease of inquiry; (iii) receiving an HCP user's selection of a disease of inquiry and EMR data relevant to such disease of inquiry; (iv) querying the treatment goal data for a disease matching the disease of inquiry, comparing the matching treatment goal data with the EMR data to determine a treatment delta; (v) selecting CME data based on the disease of inquiry and the treatment delta; and (vi) providing CME data to the HCP.

Optionally, in this process, at least a portion of the EMR data is received from one or more points of care sensor in communication with the processor. An alternative embodiment of this process includes the step of providing an evaluation inquiry to the HCP of the CME data. Some embodiments may include the step of providing a certificate of completion for the CME bearing a completion date, CME credit hours earned, and a name of the accredited CME provider. In some cases, the certificate of completion may be provided electronically. Some embodiments may include the step of maintaining a record of the CME credit completed by the HCP. In some embodiments, the clinical treatment goal level data and the EMR data comprise level 4 data or both level 3 and level 4 data.

The present invention extends to an article of manufacture, which comprises a computer readable medium. Stored on the medium may be a computer program for providing continuing medical education in a variety of educational mediums including but not limited to written material, audio, video, digital, and simulated educational formats. The program involves: (i) a first code segment which, when executed on a computer stores in a treatment goal memory clinical treatment goal level data associated with at least one or more diseases; (ii) a second code segment which, when executed on a computer stores in an education memory CME data associated with at least one or more diseases and a treatment delta, wherein the treatment delta is a difference between clinical treatment goal data and corresponding data relevant to a disease of inquiry; (iii) a third code segment which, when executed on a computer accepts an HCP user's selection of a disease of inquiry and EMR data relevant to such a disease of inquiry; (iv) a fourth code segment which, when executed on a computer queries the treatment goal data for a disease matching the disease of inquiry and compares the matching treatment goal data with the EMR data to determine a treatment delta; (v) a fifth code segment which, when executed on a computer selects CME data based on the disease of inquiry and the treatment delta; (vi) a sixth code segment which, when executed on a computer provides the CME data to the HCP user; and (vii) a seventh code segment which, when executed on a computer provides an evaluation of the CME data that was provided to the HCP.

Optionally, at least a portion of the EMR data may be received from one or more points of care sensor in communication with the processor. The program may have a number of optional code segments, such as an eighth code segment which, when executed on a computer, provides an evaluation inquiry to the HCP of the CME data. An optional ninth code segment which, when executed on a computer, may provide a certificate of completion for the CME bearing a completion date, CME credit hours earned, and a name of the accredited CME provider. In some cases, the ninth code segment may provide the certificate of completion to the at least one recipient electronically. An optional tenth code segment which, when executed on a computer, may maintain a record of CME credit completed and provides a report of the CME credit earned by the HCP. In some cases, the clinical treatment goal level data and the EMR data comprise level 4 or both level 3 and level 4 data.

Although specific embodiments have been illustrated and described herein, those of ordinary skill in the art appreciate that any arrangement which is calculated to achieve the same purpose may be substituted for the specific embodiments shown and that the invention has other applications in other environments. This application is intended to cover any adaptations or variations of the present invention. The following claims are in no way intended to limit the scope of the invention to the specific embodiments described herein.

What is claimed is:

1. An integrated continuing medical education and treatment system, comprising:
a processor coupled with a treatment goal memory for storing clinical treatment goal data associated with at least one or more disease, and also coupled with an educational memory for storing CME data associated with at least one or more disease and a treatment delta wherein the treatment delta is a difference between clinical treatment goal data and corresponding data relevant to a disease of inquiry;
wherein, the processor is adapted to receive an HCP user's selection of a disease of inquiry and EMR data relevant to any disease of inquiry;
the processor having service software executable on the processor and configured (i) to query the treatment goal data for a treatment goal data portion matching the disease of inquiry, (ii) to compare the matching treatment goal data portion with the EMR data to determine a treatment delta, (iii) to select a CME data portion based on the disease of inquiry and the treatment delta, and (iv) to provide the CME data portion to the HCP user.

2. The integrated continuing medical education and treatment system of claim 1, wherein at least a portion of the EMR data is received from one or more points of care sensor(s) in communication with the processor.

3. The integrated continuing medical education and treatment system of claim 1, wherein the service software executable on the processor is further configured to provide an evaluation inquiry to the HCP of the CME data.

4. The integrated continuing medical education and treatment system of claim 1, wherein the service software executable on the processor is further configured to provide a certificate of completion for the CME bearing a completion date, CME credit hours earned, and a name of the accredited CME provider.

5. The integrated continuing medical education and treatment system of claim 4, wherein the processor is in communication with a network having at least one recipient computer, and the service software executable on the processor is further configured to transmit over the network the certificate of completion to the at least one recipient computer.

6. The integrated continuing medical education and treatment system of claim 1, wherein the processor is coupled with a CME credit memory, the service software executable on the processor is configured to maintain a record of CME credit completed, and the service software executable on the processor is further configured to provide a report of the CME credit earned by the HCP.

7. The integrated continuing medical education and treatment system of claim 1, wherein the clinical treatment goal level data and the EMR data comprise level 4 data.

8. The integrated continuing medical education and treatment system of claim 1, wherein the clinical treatment goal level data and the EMR data comprise level 3 and 4 data.

9. A process for the integrated education of HCPs and treatment, comprising:
storing in a treatment goal memory clinical treatment goal data associated with at least one or more disease;
storing in an educational memory CME data associated with at least one or more diseases and a treatment delta, wherein the treatment delta is a difference between clinical treatment goal data and corresponding data relevant to a disease of inquiry;
receiving an HCP user's selection of a disease of inquiry and EMR data relevant to such disease of inquiry;
querying the treatment goal data for a disease matching the disease of inquiry, comparing the matching treatment goal data portion with the EMR data to determine a treatment delta;
selecting a CME data portion based on the disease of inquiry and the treatment delta;
providing CME data portion to the HCP user.

10. The process for the integrated education of HCPs and treatment of claim 9, wherein at least a portion of the EMR data is received from one or more points of care sensor in communication with the processor.

11. The process for the integrated education of HCPs and treatment of claim 9, further comprising the step of providing an evaluation inquiry to the HCP of the CME data.

12. The process for the integrated education of HCPs and treatment of claim 9, further comprising the step of providing a certificate of completion for the CME bearing a completion date, CME credit hours earned, and a name of the accredited CME provider.

13. The process for the integrated education of HCPs and treatment of claim 12, wherein the certificate of completion is provided electronically.

14. The process for the integrated education of HCPs and treatment of claim 9, further comprising the step of maintaining a record of CME credit completed by the HCP.

15. The process for the integrated education of HCPs and treatment of claim 9, wherein the clinical treatment goal level data and the EMR data comprise level 4 data.

16. The process for the integrated education of HCPs and treatment of claim 9, wherein the clinical treatment goal level data and the EMR data comprise level 3 and level 4 data.

17. An article of manufacture, which comprises a computer readable medium having stored therein a computer program for providing continuing medical education in a variety of educational mediums including but not limited to written material, audio, video, digital, and simulated educational formats, comprising:
a first code segment which, when executed on a computer stores in a treatment goal memory clinical treatment goal level data associated with at least one or more diseases;
a second code segment which, when executed on a computer stores in an education memory location CME data associated with at least one or more diseases and a treatment delta, wherein the treatment delta is a difference between a clinical treatment goal data portion and corresponding data relevant to a disease of inquiry;
a third code segment which, when executed on a computer accepts an HCP user's selection of a disease of inquiry and EMR data relevant to such a disease of inquiry;
a fourth code segment which, when executed on a computer queries the treatment goal data for a disease matching the disease of inquiry and compares the matching treatment goal data portion with the EMR data to determine a treatment delta;
a fifth code segment which, when executed on a computer selects CME data portion based on the disease of inquiry and the treatment delta portion;
a sixth code segment which, when executed on a computer provides the CME data portion to the HCP user; and
a seventh code segment which, when executed on a computer provides an evaluation of the CME data portion that was provided to the HCP.

18. The article of manufacture of claim 17, wherein at least a portion of the EMR is received from one or more points of care sensor in communication with the processor.

19. The article of manufacture of claim 17, further comprising an eighth code segment which, when executed on a computer, provides an evaluation inquiry to the HCP of the CME data.

20. The article of manufacture of claim 17, further comprising an ninth code segment which, when executed on a computer, provides a certificate of completion for the CME bearing a completion date, CME credit hours earned, and a name of the accredited CME provider.

21. The article of manufacture of claim 20, wherein the ninth code segment provides the certificate of completion to the at least one recipient electronically.

22. The article of manufacture of claim 17, further comprising a tenth code segment which, when executed on a computer, maintains a record of CME credit completed and provides a report of the CME credit earned by the HCP.

23. The article of manufacture of claim 17, wherein the clinical treatment goal level data and the EMR data comprise level 4 data.

24. The article of manufacture of claim 17, further comprising a ninth code segment which, when executed on a computer, wherein the clinical treatment goal level data and the EMR data comprise level 3 and 4 data.
